(19) United States
(12) Patent Application Publication
(10) Pub. No.: US 2018/0108994 A1
(43) Pub. Date: Apr. 19, 2018

(54) LOOP ANTENNA FOR MOBILE DEVICE

(71) Applicant: HCTM CO., LTD., Icheon-si (KR)

(72) Inventor: Seungjae LEE, Suwon-si (KR)

(21) Appl. No.: 15/567,969

(22) PCT Filed: Apr. 11, 2016
(86) PCT No.: PCT/KR2016/003798

§ 371 Date: Dec. 4, 2017

(30) Foreign Application Priority Data
Apr. 20, 2015 (KR) 10-2015-0055401
Jul. 16, 2015 (KR) 10-2015-0101033

(51) Int. Cl. H01Q 7/06; H01Q 1/24; H02J 7/02; H02J 50/10

(52) U.S. Cl. CPC H01Q 7/06; H01Q 1/241; H04B 5/0081; H02J 50/10; H02J 7/025

(57) ABSTRACT

A loop antenna for a mobile device is disclosed. The loop antenna includes a permanent magnet structure, for accommodating a permanent magnet inside the mobile device, a housing for accommodating the permanent magnet structure, and an antenna pattern unit mounted in the housing, surrounding an outer periphery of the permanent magnet.

### TECHNICAL FIELD

The present disclosure relates to a loop antenna for a mobile device, and more particularly, to a loop antenna for a mobile device, which may increase Magnetic Secure Transmission (MST) performance and wireless charging performance by forming an antenna pattern inside a magnetic field of a permanent magnet mounted in a receiver or speaker of the mobile device and thus reinforcing a signal in a band which resonates with the magnetic field.

### BACKGROUND ART

In general, a mobile device is a device capable of exchanging information such as voice, images, and data with the other party over a wireless network.

Such a mobile device is equipped with additional functions such as the functions of an e-book, an MP3 player, a camera, a recorder, a scanner, a multimedia player, and a game console. Recently, advanced devices added with the function of a tablet computer have been commercialized as smartphones.

Besides the above additional functions, Near Field Communication (NFC) that enables data communication in a preset frequency band within a short range, Magnetic Secure Transmission (MST) that senses information and processes payment when a device containing credit card information contacts a magnetic payment terminal, wireless charging technology that charges a mobile device wirelessly within a predetermined distance by magnetic resonance, and so on have been developed. Addition of various functions to a mobile device leads to an increase in the utilization of the mobile device.

In order to implement these technologies, an antenna configured to transmit and receive frequency signals and magnetic force signals by resonance is used.

Since an antenna should be additionally installed in a mobile device to transmit and receive different types of signals such as a frequency signal and a magnetic force signal according to additional functions executed in the mobile device, the fabrication cost and volume of the mobile device may be increased.

Moreover, a case of the mobile device has recently been fabricated of a metal which may cause interference to a wireless signal, thereby decreasing the transmission and reception efficiency of signals.

### DISCLOSURE

### Technical Problem

Accordingly, to overcome limitations and disadvantages of the related art, an aspect of the present disclosure is to provide a loop antenna for a mobile device, which may increase the transmission and reception efficiency of signals, enables Magnetic Secure Transmission (MST) that uses a magnetic force signal and transmission and reception of wireless charging signals, and thus render the mobile device to be multi-functional and versatile, by forming an antenna pattern in an area in which a magnetic field of a permanent magnet structure with a permanent magnet among various parts of the mobile device is generated, and thus amplifying a transmission and reception frequency band through mutual resonation between a magnetic force and signals transmitted to and received from the antenna pattern.

Additional advantages, objects, and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure particularly pointed out in the written description and claims hereof as well as the appended drawings.

### Technical Solution

To achieve these objects and other advantages and in accordance with the purpose of the present disclosure, as embodied and broadly described herein, a loop antenna for a mobile device includes a permanent magnet structure, for accommodating a permanent magnet inside the mobile device, a housing for accommodating the permanent magnet structure, and an antenna pattern unit mounted in the housing, surrounding an outer periphery of the permanent magnet.

Further, the permanent magnet structure may be a speaker.

The permanent magnet structure may be a receiver.

Further, the antenna pattern unit may be installed on an inner surface of the housing, surrounding a magnetic field of the permanent magnet.

Further, the antenna pattern unit may be inserted into a side surface of the housing.

Further, the antenna pattern unit may include an antenna coil in the form of coils.

Further, the antenna pattern unit may include a flexible printed circuit board having an antenna pattern printed thereon.

Further, the antenna pattern unit may include a plated substrate having a plated pattern.

Further, the antenna pattern unit may include a sheet metal in the form of a pattern.

Further, the loop antenna may further include a magnetic field inductor mounted in the housing and disposed between the antenna pattern unit and the permanent magnet.

Further, the loop antenna may further include a magnetic field inductor in the vicinity of the antenna pattern unit in the housing.

Further, the magnetic field inductor may be formed of a metal.

Further, the magnetic field inductor may be formed of ferrite.

According to another aspect of the present disclosure, a loop antenna for a mobile device includes a display panel mounted in the mobile device, and an antenna pattern unit mounted at a position of the display panel, opposite to a permanent magnet structure for accommodating a permanent magnet inside the mobile device.

Further, the permanent magnet structure may be a speaker.

Further, the permanent magnet structure may be a receiver.

Further, the antenna pattern unit may be formed on a bottom surface of the display panel, facing the permanent magnet structure.

Further, the antenna pattern unit may be formed on a top surface of the display panel, opposite to a surface facing the permanent magnet structure.

Further, the antenna pattern unit may be inserted into the display panel.

Further, the antenna pattern unit may include an antenna coil in the form of coils.

Further, the antenna pattern unit may include a flexible printed circuit board having an antenna pattern printed thereon.

Further, the antenna pattern unit may include a plated substrate having a plated pattern.

Further, the antenna pattern unit may include a sheet metal in the form of a pattern.

It is to be understood that both the foregoing general description and the following detailed description of the present disclosure are exemplary and explanatory and are intended to provide further explanation of the present disclosure as claimed.

### Advantageous Effects

In a loop antenna for a mobile device according to an embodiment of the present disclosure, since the antenna is installed at a position at which interference of a magnetic force of a permanent magnet structure with a permanent magnet mounted therein is minimized, that is, within or into a housing, the transmission and reception efficiency of signals may be increased, and the use of an existing structure may reduce fabrication cost.

Further, since a loop antenna for a mobile device according to an embodiment of the present disclosure transmits and receives signals through resonation with a magnetic field generated from an installed magnet, the loop antenna may transmit and receive a magnetic force signal as well as a frequency signal by communication. The resulting capability of transmitting and receiving a magnetic force signal such as a Magnetic Secure Transmission (MST) signal and a wireless charging signal as well as a Near Field Communication (NFC) frequency band signal enables execution of various functions in the single antenna, thus increasing the versatility of the antenna.

Further, as a loop antenna for a mobile device according to an embodiment of the present disclosure is configured so as to transmit and receive signals using a magnetic field of a magnet, wave interference of a metal case is minimized. As a consequence, antenna reception efficiency is increased, thereby increasing performance.

Further, a loop antenna for a mobile device according to an embodiment of the present disclosure is installed within a housing of a speaker or receiver in which an antenna pattern may be supported within a magnetic field generation area of a permanent magnet installed in the speaker or receiver, or on a display panel. Thus, an existing part may be utilized without an additional component to an existing mobile device, thereby reducing cost.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### DESCRIPTION OF DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a use state diagram illustrating an installation state of a loop antenna for a mobile device according to the present disclosure;

FIG. 2 is a sectional view illustrating an embodiment of an antenna pattern unit being an important component in a loop antenna for a mobile device according to an embodiment of the present disclosure;

FIG. 3 is a sectional view illustrating another embodiment of the antenna pattern unit being an important component in the loop antenna for a mobile device, illustrated in FIG. 2;

FIG. 4 is a sectional view illustrating a third embodiment of the antenna pattern unit being an important component in the loop antenna for a mobile device, illustrated in FIG. 2;

FIG. 5 is a sectional view illustrating a fourth embodiment of the antenna pattern unit being an important component in the loop antenna for a mobile device, illustrated in FIG. 2;

FIG. 6 is a sectional view illustrating a loop antenna for a mobile device according to another embodiment of the present disclosure;

FIG. 7 is a sectional view illustrating another embodiment of a magnetic field inductor being an important component of the loop antenna for a mobile device, illustrated in FIG. 6;

FIG. 8 is a sectional view illustrating the first embodiment of an antenna pattern unit being an important component in a loop antenna for a mobile device according to a third embodiment of the present disclosure;

FIG. 9 is a sectional view illustrating the second embodiment of the antenna pattern unit being an important component in the loop antenna for a mobile device, illustrated in FIG. 8;

FIG. 10 is a sectional view illustrating the third embodiment of the antenna pattern unit being an important component in the loop antenna for a mobile device, illustrated in FIG. 8;

FIG. 11 is a sectional view illustrating the fourth embodiment of the antenna pattern unit being an important component in the loop antenna for a mobile device, illustrated in FIG. 8;

FIG. 12 is a sectional view illustrating a loop antenna for a mobile device according to a fourth embodiment of the present disclosure;

FIG. 13 is a sectional view illustrating a loop antenna for a mobile device according to a fifth embodiment of the present disclosure;

FIG. 14 is a sectional view illustrating a loop antenna for a mobile device according to a sixth embodiment of the present disclosure; and

FIG. 15 is a sectional view illustrating a loop antenna for a mobile device according to a seventh embodiment of the present disclosure.

### BEST MODE

Objects, advantages, and technical structures for achieving them will become apparent upon examination of the following detailed description of embodiments of the present disclosure as well as the attached drawings. In the description of the present disclosure, a detailed description of known functions or configurations will be omitted lest it should obscure the subject matter of the present disclosure. The terms as set forth herein are defined in consideration of the structures, roles, and functions of the present disclosure, and may vary according to the intent of a user and an operator, or customs.

However, the present disclosure is not limited to the disclosed embodiments. Rather, the present disclosure may be implemented in various other ways. The embodiments are provided to make the disclosure of the present disclosure comprehensive and help those skilled in the art to comprehensively understand the scope of the present disclosure, and the present disclosure is defined only by the appended claims. Therefore, the definition should be made based on the overall contents of the specification.

With reference to the attached drawings, a loop antenna for a mobile device according to an embodiment of the present disclosure will be described below in detail.

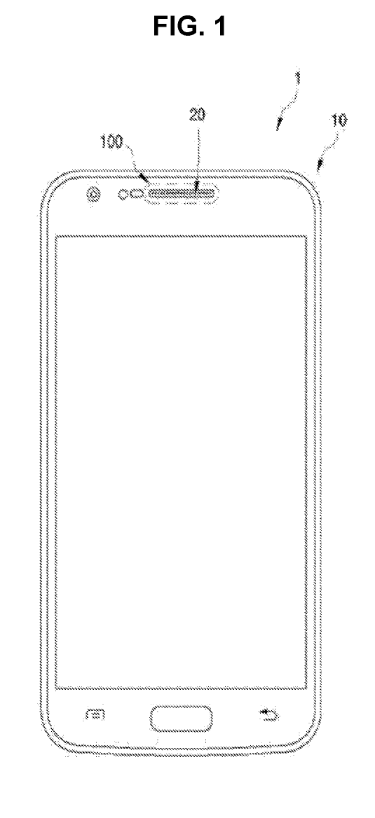

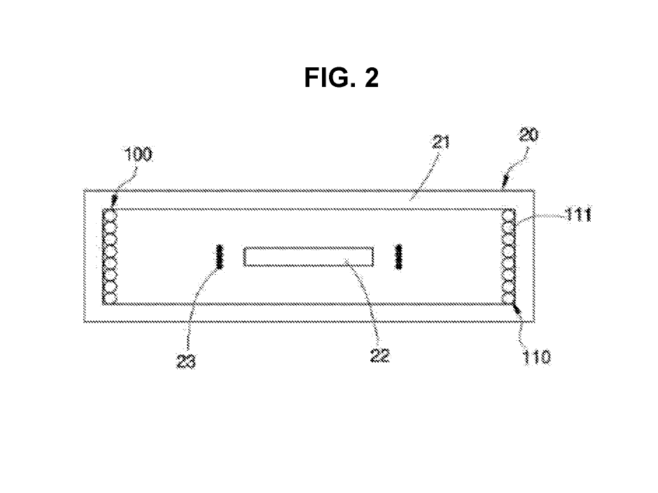

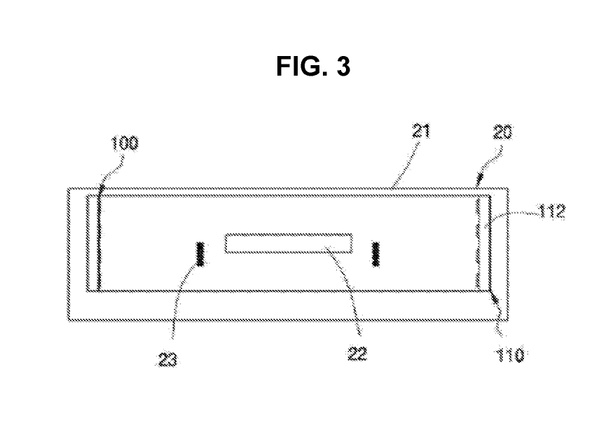

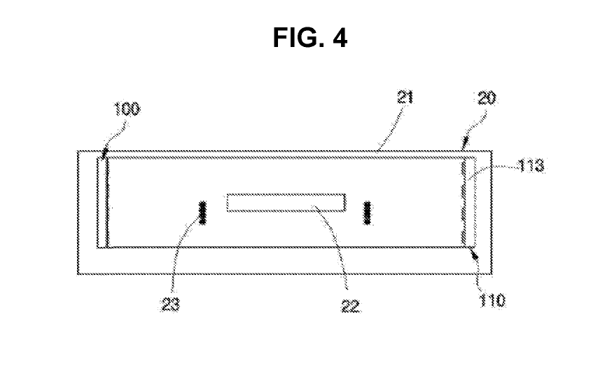

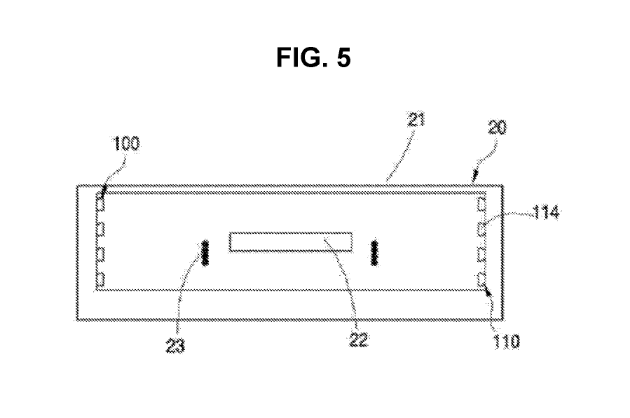

FIG. 1 is a use state diagram illustrating an installation state of a loop antenna for a mobile device according to the present disclosure, FIG. 2 is a sectional view illustrating an embodiment of an antenna pattern unit being an important component in a loop antenna for a mobile device according to an embodiment of the present disclosure, FIG. 3 is a sectional view illustrating another embodiment of the antenna pattern unit being an important component in the loop antenna for a mobile device, illustrated in FIG. 2, FIG. 4 is a sectional view illustrating a third embodiment of the antenna pattern unit being an important component in the loop antenna for a mobile device, illustrated in FIG. 2, and FIG. 5 is a sectional view illustrating a fourth embodiment of the antenna pattern unit being an important component in the loop antenna for a mobile device, illustrated in FIG. 2.

Referring to FIGS. 1 to 5, a loop antenna 100 for a mobile device according to an embodiment of the present disclosure is installed inside a speaker 20 including a permanent magnet 22 among parts installed in a mobile device 1, in order to perform transmission and reception, or charging through mutual resonation of a Near Field Communication (NFC) signal, a Magnetic Secure Transmission (MST) signal, and a wireless charging signal.

The speaker 20 is an exemplary permanent magnet structure with the permanent magnet 22 mounted therein in the mobile device 1, for the convenience of description. The loop antenna 100 for a mobile device is applicable to any part with the permanent magnet 22 mounted therein in the mobile device 1. Particularly, the loop antenna 100 for a mobile device may be installed in, but not limited to, a receiver with the permanent magnet 22 mounted therein. Particularly, the permanent magnet structure according to an embodiment of the present disclosure is not limited to a permanent magnet structure in which a coil is wound around a permanent magnet, such as the afore-described speaker or receiver. In other words, the loop antenna 100 for a mobile device is applicable to any part with a permanent magnet mounted therein.

In the above-described speaker 20 of the mobile device 1, a housing 21 is mounted in a voice output part at a portion of a case 10. The permanent magnet 22 around which a speaker coil 23 is wound is installed inside the housing 21, to resonate for voice output. Herein, various parts for generating voice according to a signal resonated through interaction between the permanent magnet 22 and the speaker coil 23 may be installed in the speaker 20, which is a well-known technology. Accordingly, such various parts are neither illustrated nor described.

As described above, the permanent magnet 22 mounted in the speaker 20 produces a magnetic field area to enable mutual resonation between the permanent magnet 22 and the speaker coil 23 and thus generate a sound by vibration. Therefore, if the loop antenna 100 is provided around the housing 21 and generates a magnetic field within a magnetic field generated by the permanent magnet 22, the magnetic fields may create synergy, thereby increasing transmission and reception efficiency.

That is, as the loop antenna 100 transmits and receives signals, using the magnetic field generated from the permanent magnet 22, the loop antenna 100 may amplify a transmitted or received frequency signal, thereby increasing the transmission and reception efficiency of an NFC signal and transmitting and receiving magnetic force signals used for MST and wireless charging.

Since the loop antenna 100 for a mobile device is mounted inside the mobile device 1 and uses a magnetic field of the magnet, the loop antenna 100 may increase a signal strength during transmission and reception of an NFC frequency signal, and thus increase transmission and reception efficiency even though the loop antenna 100 is installed within a metal case.

Further, as the loop antenna 100 for a mobile device is installed in the mobile device 1 and is capable of transmitting and receiving magnetic force signals using a magnetic field, if the mobile device 1 contacts a magnetic terminal by MST, authentication information entered in the mobile device 1 may be checked for payment and identification.

Further, if the loop antenna 100 for a mobile device is installed inside the mobile device 1, the loop antenna 100 may transmit and receive magnetic force signals, using a magnetic field. Therefore, if the loop antenna 100 is located in the vicinity of a body that generates a magnetic force, the loop antenna 100 may charge the mobile device 1 through mutual resonance or induction of a magnetic force by a wireless charging technology.

This loop antenna 100 for a mobile device according to the first embodiment of the present disclosure includes an antenna pattern unit 110 surrounding an outer periphery of the permanent magnet 22, inside the housing 21 of the speaker 20 which is mounted in the mobile device 1 and has the permanent magnet 22 mounted therein.

The antenna pattern unit 110 surrounds the permanent magnet 22 within a magnetic field area of the permanent magnet 22, on an inner surface of the housing 21.

As the antenna pattern unit 110 is installed on the inner surface of the housing 21 with the permanent magnet 22 therein, if power is supplied, a magnetic field generated by the permanent magnet 22 amplifies an NFC frequency signal during transmission and reception of the NFC frequency signal within the magnetic field of the permanent magnet 22, thereby minimizing the effect of external interference and increasing the transmission and reception efficiency of the NFC signal.

That is, since the antenna pattern unit 110 transmits and receives a signal after the signal is amplified in the magnetic field generated by the permanent magnet 22 of the speaker 20, even though the antenna pattern unit 110 is mounted inside a case (not shown) formed of a metal which is a signal interfering material, the efficiency of transmission and reception may be increased due to the amplified signal.

Further, as the antenna pattern unit 110 surrounds the permanent magnet 22 within the magnetic field of the permanent magnet 22, on the inner surface of the housing 21, the antenna pattern unit 110 may transmit and receive magnetic force signals such as an MST signal and a wireless charging signal as well as an NFC frequency signal. The resulting capability of executing various functions in the single antenna may increase versatility.

That is, since the antenna pattern unit 110 may amplify a received frequency signal and transmit and receive a magnetic force signal within the magnetic field of the permanent magnet 22 of the speaker 20, the antenna pattern unit 110 is wound a plurality of times on the inner surface of the housing 21 facing the permanent magnet 22 in order to execute the function of transmitting and receiving an authentication signal or the function of charging by generation of power based on resonance.

FIG. 2 illustrates an embodiment of the antenna pattern unit 110 which is an important component of the loop antenna 100 for a mobile device according to the first embodiment of the present disclosure. The antenna pattern unit 110 is configured as an antenna coil 111 wound on the inner surface of the housing 21, surrounding the permanent magnet 22. The antenna coil 111 is configured so that patterns taking the form of coils may be wound a plurality of times on the inner surface of the housing 21 facing the permanent magnet 22 within the magnetic field of the permanent magnet 22 inside the housing 21. The antenna coil 111 may be wound in the form of coils at a position facing the permanent magnet 22 without an interfering structure in the housing 21, so that when power is supplied, the antenna coil 111 may transmit and receive frequency signals.

FIG. 3 illustrates another embodiment of the antenna pattern unit 110 which is an important component of the loop antenna 100 for a mobile device according to the first embodiment of the present disclosure. The antenna pattern unit 110 is configured as a Flexible Printed Circuit Board (FPCB) 112 with a pattern printed thereon on the inner surface of the housing 21, surrounding the permanent magnet 22. The FPCB 112 is provided with a pattern for transmitting and receiving signals within the magnetic field of the permanent magnet 22, printed on a substrate formed of a flexible material. The FPCB 112 may be installed on the inner surface of the housing 21 facing the permanent magnet 22 without an interfering structure inside the housing 21 so as to transmit and receive signals within the magnetic field of the permanent magnet 22.

FIG. 4 illustrates a third embodiment of the antenna pattern unit 110 which is an important component of the loop antenna 100 for a mobile device according to the first embodiment of the present disclosure. The antenna pattern unit 110 is configured as a plated substrate 113 with a plated pattern on the inner surface of the housing 21, surrounding the permanent magnet 22. The plated substrate 113 is provided with a pattern plated on a substrate formed of a flexible material, for transmitting and receiving signals within the magnetic field of the permanent magnet 22. The plated substrate 113 may be installed on the inner surface of the housing 21 facing the permanent magnet 22 without an interfering structure inside the housing 21 so as to transmit and receive signals within the magnetic field of the permanent magnet 22.

FIG. 5 illustrates a fourth embodiment of the antenna pattern unit 110 which is an important component of the loop antenna 100 for a mobile device according to the first embodiment of the present disclosure. The antenna pattern unit 110 is configured as sheet metals 114 in the form of patterns on the inner surface of the housing 21, surrounding the permanent magnet 22. The sheet metals 114 are conductive thin-film sheet metals in the form of patterns, for transmitting and receiving signals within the magnetic field of the permanent magnet 22. The sheet metals 114 are conductive thin-film sheet metals provided on the inner surface of the housing 21, for transmitting and receiving signals within the magnetic field of the permanent magnet 22. The sheet metals 114 may be installed on the inner surface of the housing 21 facing the permanent magnet 22 without an interfering structure inside the housing 21 so as to transmit and receive signals within the magnetic field of the permanent magnet 22.

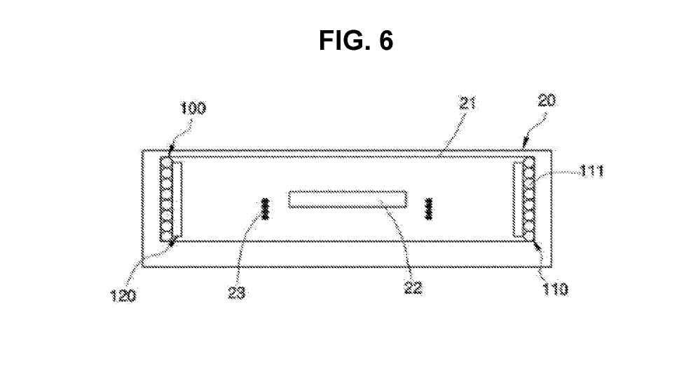

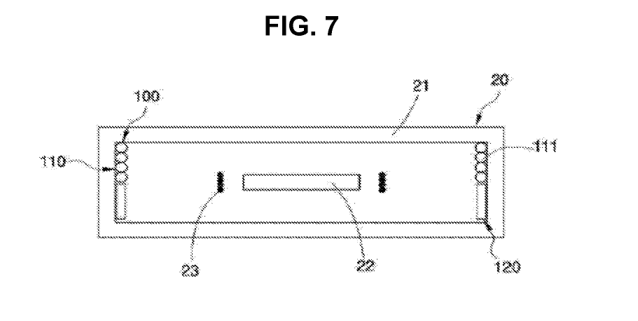

FIG. 6 is a sectional view illustrating a loop antenna for a mobile device according to another embodiment of the present disclosure, and FIG. 7 is a sectional view illustrating another embodiment of a magnetic field inductor being an important component of the loop antenna for a mobile device, illustrated in FIG. 6.

Referring to FIGS. 6 and 7, the loop antenna 100 for a mobile device according to the second embodiment of the present disclosure includes the antenna pattern unit 110 and a magnetic field inductor 120 in the housing 21. The structures and plural embodiments of the loop antenna 100 for a mobile device, illustrated in FIGS. 1 to 5 are applicable to the antenna pattern unit 110 and thus a detailed description of the antenna pattern unit 110 will be omitted herein, with a different component, the magnetic field inductor 120 focused on.

The magnetic field inductor 120 is provided inside the housing 21, and disposed between the permanent magnet 22 and the antenna pattern unit 110, surrounding the outer periphery of the permanent magnet 22. The magnetic field inductor 120 is installed between the permanent magnet 22 and the antenna pattern unit 110 in order to induce a magnetic field generated by the permanent magnet 22 and thus increase the transmission and reception efficiency of the antenna pattern unit 110. Because the magnetic field inductor 120 increases magnetic field generation efficiency by inducing a magnetic field generated by the permanent magnet 22, the magnetic field inductor 120 may amplify transmission and reception signals by current applied to the antenna pattern unit 110, thereby increasing the transmission and reception efficiency of the signals.

The magnetic field inductor 120 is preferably formed of a material that induces a magnetic field in order to increase the magnetic field generation efficiency of the permanent magnet 22 and thus increase the transmission and reception efficiency of signals through amplification of transmission and reception signals by application of current to the antenna pattern unit 110.

The magnetic field inductor 12 is formed of a material that induces the magnetic field of the permanent magnet 22 when power is supplied to the coil-type antenna pattern unit 110. Preferably, the magnetic field inductor 120 may be formed of a material selected from a metal and ferrite which is a magnetic material.

Referring to FIG. 7, according to another embodiment of the magnetic field inductor 120 which is an important component of the loop antenna 100 for a mobile device according to the second embodiment of the present disclosure, the antenna pattern unit 110 may be provided on a part of the inner surface of the housing 21, and the magnetic field inductor 120 may be provided on the remaining part of the inner surface of the housing 21, surrounding the permanent magnet 22.

The magnetic field inductor 120 may be provided on the remaining part of the inner surface of the housing 21 facing the permanent magnet 22, apart from the antenna pattern unit 110 without overlap between the magnetic field inductor 120 and the antenna pattern unit 110, surrounding the permanent magnet 22, to thereby increase the transmission and reception efficiency of the antenna pattern unit 110 and thus to induce the magnetic field of the permanent magnet 22.

The magnetic field inductor 120 is preferably formed of a material that induces a magnetic field in order to increase the magnetic field generation efficiency of the permanent magnet 22 and thus increase the transmission and reception efficiency of the antenna pattern unit 110 through amplification of a transmission and reception signal by application of current to the antenna pattern unit 110.

The magnetic field inductor 12 is formed of a material that induces the magnetic field of the permanent magnet 22 when power is supplied to the coil-type antenna pattern unit 110. Preferably, the magnetic field inductor 120 may be formed of a material selected from a metal and ferrite which is a magnetic material.

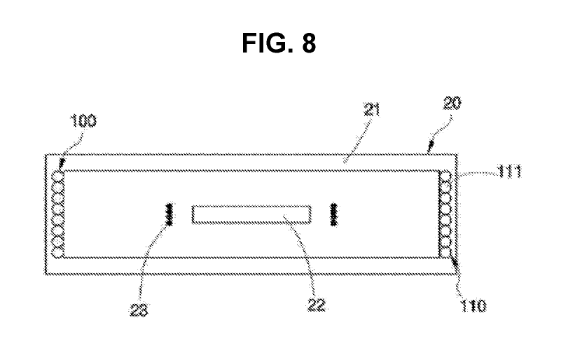

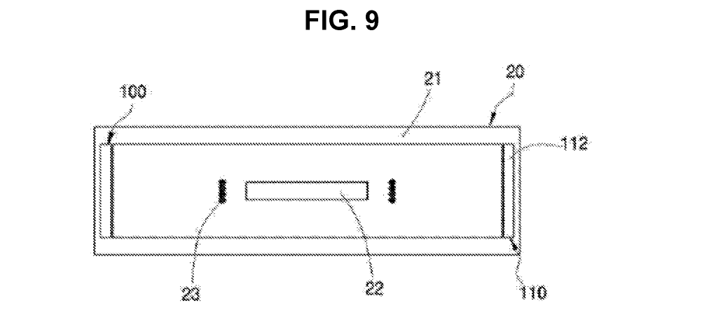

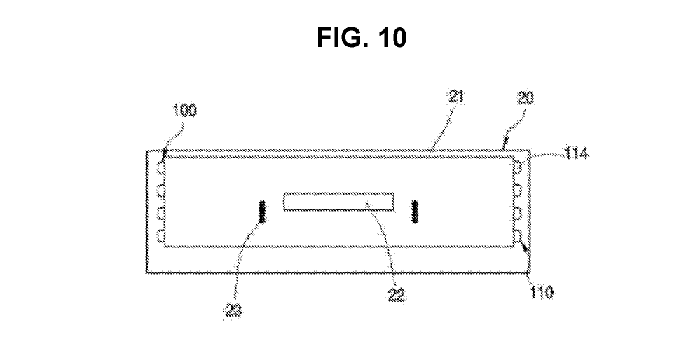

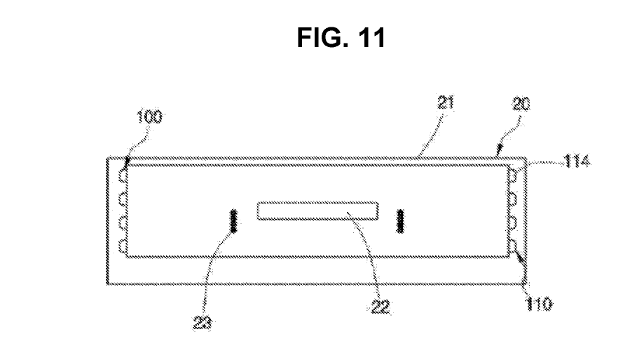

FIG. 8 is a sectional view illustrating the first embodiment of an antenna pattern unit being an important component in a loop antenna for a mobile device according to a third embodiment of the present disclosure, FIG. 9 is a sectional view illustrating the second embodiment of the antenna pattern unit being an important component in the loop antenna for a mobile device, illustrated in FIG. 8, FIG. 10 is a sectional view illustrating the third embodiment of the antenna pattern unit being an important component in the loop antenna for a mobile device, illustrated in FIG. 8, and FIG. 11 is a sectional view illustrating the fourth embodiment of the antenna pattern unit being an important component in the loop antenna for a mobile device, illustrated in FIG. 8.

Referring to FIGS. 8 to 11, the loop antenna 100 for a mobile device according to the third embodiment of the present disclosure includes the antenna pattern unit 110 integrally inserted inward into the housing 21, surrounding the outer periphery of the permanent magnet 22 in the speaker 20 installed in the mobile device 1 and having the permanent magnet 22 therein.

The antenna pattern unit 110 is built in to be integrally inserted inward into the housing 21, surrounding the permanent magnet 22 within the magnetic field of the permanent magnet 22.

As the antenna pattern unit 110 is integrally built in, inserted inward into the housing 21 with the permanent magnet 22 therein, if power is supplied, the magnetic field generated by the permanent magnet 22 amplifies an NFC frequency signal during transmission and reception of the NFC frequency signal in the magnetic field, thereby minimizing the effect of external interference and increasing the transmission and reception efficiency of the

NFC signal.

That is, as a signal is transmitted and received after being amplified in the magnetic field generated by the permanent magnet 22 of the speaker 20, even though the antenna pattern unit 110 is mounted inside a case formed of a metal which is a material interfering a signal, the efficiency of transmission and reception may be increased due to the amplified signal.

Further, as the antenna pattern unit 110 is inserted into the housing 21 in a direction facing the permanent magnet 22 within the magnetic field of the permanent magnet 22, surrounding the permanent magnet 22, the antenna pattern unit 110 may transmit and receive magnetic force signals. Thus, the antenna pattern unit 110 may transmit and receive magnetic force signals such as an MST signal and a wireless charging signal as well as an NFC frequency signal, thereby enabling the single antenna 100 to execute various functions and thus increasing versatility.

That is, since the antenna pattern unit 110 may amplify a received frequency signal within the magnetic field of the permanent magnet 22 of the speaker 20 and transmit and receive a magnetic force signal, the antenna pattern unit 110 is wound a plurality of times on the inner surface of the housing 21 facing the permanent magnet 22 in order to execute the function of transmitting and receiving an authentication signal or the function of charging by generation of power based on resonance.

FIG. 8 illustrates the first embodiment of the antenna pattern unit 110 which is an important component of the loop antenna 100 for a mobile device according to the third embodiment of the present disclosure. The antenna pattern unit 110 is configured as the antenna coil 111 which is wound and built in the housing by being inserted into the housing 21, surrounding the permanent magnet 22. The antenna coil 111 is built in the housing 21 so that patterns taking the form of coils may be wound a plurality of times, inserted inward into the housing 21 facing the permanent magnet 22, and reside within the magnetic field of the permanent magnet 22 installed in the housing 21. The antenna coil 111 may be wound in the form of coils built in the housing 21, facing the permanent magnet 22, so that when power is supplied, the antenna coil 111 may transmit and receive frequency signals.

FIG. 9 illustrates another embodiment of the antenna pattern unit 110 which is an important component of the loop antenna 100 for a mobile device according to the third embodiment of the present disclosure. The antenna pattern unit 110 is configured as the FPCB 112 with a pattern for transmitting and receiving signals within the magnetic field of the permanent magnet 22, printed on a substrate formed of a flexible material. The FPCB 112 may be built in the housing 21 by being inserted inward into the housing 21, facing the permanent magnet 22 so as to transmit and receive signals within the magnetic field of the permanent magnet 22.

FIG. 10 illustrates a third embodiment of the antenna pattern unit 110 which is an important component of the loop antenna 100 for a mobile device according to the third embodiment of the present disclosure. The antenna pattern unit 110 is configured as the plated substrate 113 with a plated pattern surrounding the permanent magnet 22, which is inserted inward into the housing 21. The plated substrate 113 is provided with a patterns plated on a substrate formed of a flexible material, for transmitting and receiving signals within the magnetic field of the permanent magnet 22. The plated substrate 113 may be built in the housing 21 by being inserted inward into the housing 21 in a direction facing the permanent magnet 22 so as to transmit and receive signals within the magnetic field of the permanent magnet 22.

FIG. 11 illustrates a fourth embodiment of the antenna pattern unit 110 which is an important component of the loop antenna 100 for a mobile device according to the third embodiment of the present disclosure. The antenna pattern unit 110 is configured as the sheet metals 114 in the form of patterns surrounding the permanent magnet 22, which is inserted inward into the housing 21. The sheet metals 114 are conductive thin-film sheet metals in the form of patterns, for transmitting and receiving signals within the magnetic field of the permanent magnet 22. The sheet metals 114 are conductive thin-film sheet metals built in the housing 21 by being inserted inward into the housing 21 so as to transmit and receive signals within the magnetic field of the permanent magnet 22. The sheet metals 114 may be built in the housing 21 by being inserted inward into the housing 21 in a direction facing the permanent magnet 22 so as to transmit and receive signals within the magnetic field of the permanent magnet 22.

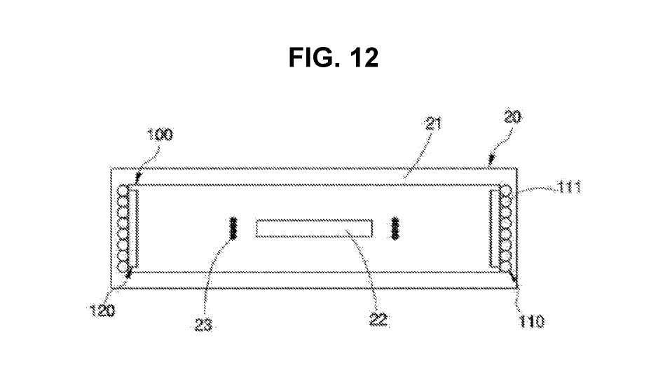

FIG. 12 is a sectional view illustrating a loop antenna for a mobile device according to a fourth embodiment of the present disclosure.

Referring to FIG. 12, the loop antenna 100 for a mobile device according to the fourth embodiment of the present disclosure includes the antenna pattern unit 110 and the magnetic field inductor 120 inside the housing 21. The structures and plural embodiments of the loop antenna 100 for a mobile device, illustrated in FIGS. 8 to 11 are applicable to the antenna pattern unit 110 and thus a detailed description of the antenna pattern unit 110 will be omitted herein, with a different component, the magnetic field inductor 120 focused on.

The magnetic field inductor 120 is provided in the housing 21 and disposed between the permanent magnet 22 and the antenna pattern unit 110 built inward into the housing 21, surrounding the outer periphery of the permanent magnet 22. The magnetic field inductor 120 is installed between the permanent magnet 22 and the antenna pattern unit 110 in order to induce the magnetic field generated by the permanent magnet 22 and thus increase the transmission and reception efficiency of the antenna pattern unit 110. Because the magnetic field inductor 120 increases magnetic field generation efficiency by inducing the magnetic field generated by the permanent magnet 22, the magnetic field inductor 120 may amplify transmission and reception signals by current applied to the antenna pattern unit 110, thereby increasing the transmission and reception efficiency of the signals.

The magnetic field inductor 120 and the antenna pattern unit 110 may be inserted together into the housing 21 or may be installed on the inner surface of the housing 21, surrounding the permanent magnet 22. The configuration of the magnetic field inductor 120 depends on user selection, and it is apparent to those skilled in the art that as far as the magnetic field inductor 120 is disposed between the permanent magnet 22 and the antenna pattern unit 110, any configuration is available for the magnetic field inductor 120.

The magnetic field inductor 120 is preferably formed of a material that induces a magnetic field in order to increase the magnetic field generation efficiency of the permanent magnet 22 and thus increase the transmission and reception efficiency of the antenna pattern unit 110 through amplification of a transmission and reception signal by application of current to the antenna pattern unit 110.

The magnetic field inductor 120 is formed of a material that induces the magnetic field of the permanent magnet 22 when power is supplied to the coil-type antenna pattern unit 110. Preferably, the magnetic field inductor 120 may be formed of a material selected from a metal and ferrite which is a magnetic material.

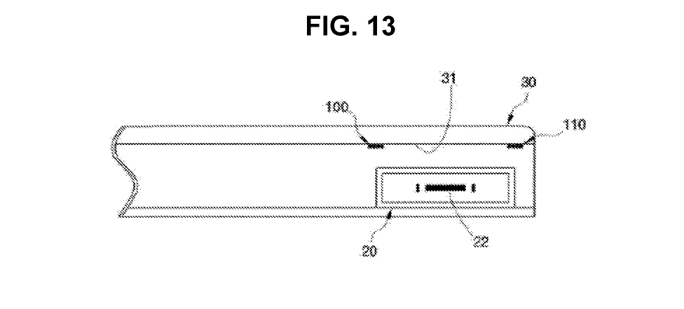

FIG. 13 is a sectional view illustrating a loop antenna for a mobile device according to a fifth embodiment of the present disclosure.

Referring to FIG. 13, the loop antenna 100 for a mobile device according to the fifth embodiment of the present disclosure is installed within the magnetic field area of the permanent magnet 22 on the bottom surface of a panel housing 31, facing the speaker 20, in a display panel which is a panel displaying various screens through touch manipulation, apart from the front surface of the speaker 20 having the permanent magnet 22 therein among the parts of the mobile device 1, in order to perform transmission and reception, or charging through mutual resonation of an NFC signal, an MST signal, and a wireless charging signal.

The speaker 20 is an exemplary permanent magnet structure with the permanent magnet 22 mounted therein in the mobile device 1, for the convenience of description. The loop antenna 100 for a mobile device is installed at a position surrounding the magnetic force generation area of the permanent magnet 22 on the surface of the panel housing facing the permanent magnet structure in the display panel 30, above the permanent magnet 22, and is applicable to any part with the permanent magnet 22 installed therein in the mobile device 1. Particularly, the loop antenna 100 for a mobile device may be installed in, but not limited to, the panel housing 31 of the display panel 30 positioned on a surface facing a receiver with the permanent magnet 22 installed therein. Particularly, the permanent magnet structure according to an embodiment of the present disclosure is not limited to a permanent magnet structure in which a coil is wound around a permanent magnet, such as the afore-described speaker or receiver. In other words, the loop antenna 100 for a mobile device is applicable to any part including a permanent magnet.

The above-described loop antenna 100 for a mobile device includes the antenna pattern unit 110 which is installed on the surface of the panel housing 31 facing the speaker 20, surrounding a magnetic force area of the permanent magnet 22, the panel housing 31 serving as a case of the display panel 30 apart from the speaker 20 using a magnetic force, in front of the speaker 20.

The antenna pattern unit 110 is installed on the panel housing 31 serving as a case of the display panel 30 disposed in the vicinity of the speaker 20 among the parts of the mobile device 1, so that the antenna pattern unit 110 may be located within the magnetic field area of the permanent magnet 22 inside the speaker 20. The antenna pattern unit 110 is installed on the surface of the panel housing 31 facing the permanent magnet 22 within the magnetic field area of the permanent magnet 22, surrounding the permanent magnet 22 for mutual resonation in the magnetic field of the permanent magnet 22.

This antenna pattern unit 110 is installed on the surface of the panel housing 31 facing the speaker 20. Various configurations according to the first to fourth embodiments of the antenna pattern unit 110 illustrated in FIGS. 2 to 5 are applicable to the antenna pattern unit 110. That is, the loop antenna 100 for a mobile device according to the fifth embodiment is identical to the loop antenna 100 for a mobile device according to the first embodiment, in terms of principle and installation configuration, and the former is different from the latter only in terms of installation position. Accordingly, the first to fourth embodiments of the antenna pattern unit 110 in the loop antenna 100 for a mobile device according to the first embodiment are available herein, and thus will not be described in detail.

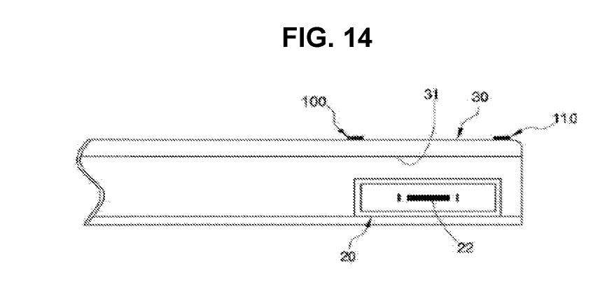

FIG. 14 is a sectional view illustrating a loop antenna for a mobile device according to a sixth embodiment of the present disclosure.

Referring to FIG. 14, the loop antenna 100 for a mobile device according to the fifth embodiment of the present disclosure is installed inside the magnetic field area of the permanent magnet 22 on a surface opposite to a surface of a panel housing 31 facing the speaker 20, in the display panel 30 which is a panel displaying various screens through touch manipulation, apart from the front surface of the speaker 20 having the permanent magnet 22 among the parts of the mobile device 1, in order to perform transmission and reception, or charging through mutual resonation of an NFC signal, an MST signal, and a wireless charging signal.

The antenna pattern unit 110 is installed on the surface opposite to the surface of the panel housing 31 facing the speaker 20, surrounding the magnetic field area of the permanent magnet 22. This antenna pattern unit 110 is different from the antenna pattern unit 110 in the loop antenna for a mobile device according to the fifth embodiment illustrated in FIG. 13, in terms of their installation positions in the panel housing 31, whereas they are identical in configuration. Thus, a detailed description of the antenna pattern unit 110 will not be provided herein. Further, various configurations according to the first to fourth embodiments of the antenna pattern unit 110 illustrated in FIGS. 2 to 5 are applicable to the antenna pattern unit 110.

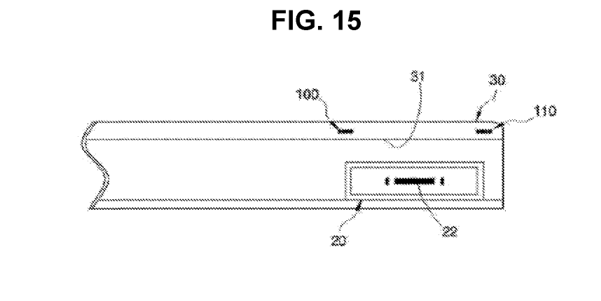

FIG. 15 is a sectional view illustrating a loop antenna for a mobile device according to a seventh embodiment of the present disclosure.

Referring to FIG. 15, the loop antenna 100 for a mobile device according to the seventh embodiment of the present disclosure is inserted into the panel housing 31 facing the speaker 20, in the display panel 30 which is a panel displaying various screens through touch manipulation, apart from the front surface of the speaker 20 having the permanent magnet 22 among the parts of the mobile device 1, in order to perform transmission and reception, or charging through mutual resonation of an NFC signal, an MST signal, and a wireless charging signal.

The antenna pattern unit 110 is inserted into the he speaker 20 and the panel housing 31, surrounding the magnetic field area of the permanent magnet 22. This antenna pattern unit 110 is different from the antenna pattern unit 110 in the loop antenna for a mobile device according to the fifth embodiment illustrated in FIG. 13, in terms of their installation positions in the panel housing 31, whereas they are identical in configuration. Thus, a detailed description of the antenna pattern unit 110 will not be provided herein. Further, various configurations according to the first to fourth embodiments of the antenna pattern unit 110 illustrated in FIGS. 2 to 5 are applicable to the antenna pattern unit 110.

It will be apparent to those skilled in the art that various modifications and variations can be made in the present disclosure without departing from the spirit or scope of the present disclosure. Thus, it is intended that the present disclosure covers the modifications and variations of this present disclosure provided they come within the scope of the appended claims and their equivalents.

1. A loop antenna for a mobile device, the loop antenna comprising:
a permanent magnet structure, for accommodating a permanent magnet inside the mobile device;
a housing for accommodating the permanent magnet structure; and
an antenna pattern unit mounted in the housing, surrounding an outer periphery of the permanent magnet.

2. The loop antenna according to claim 1, wherein the permanent magnet structure is a speaker.

3. The loop antenna according to claim 1, wherein the permanent magnet structure is a receiver.

4. The loop antenna according to claim 1, wherein the antenna pattern unit is installed on an inner surface of the housing, surrounding a magnetic field of the permanent magnet.

5. The loop antenna according to claim 1, wherein the antenna pattern unit is inserted into a side surface of the housing.

6. The loop antenna according to claim 4, wherein the antenna pattern unit includes an antenna coil in the form of coils.

7. The loop antenna according to claim 4, wherein the antenna pattern unit includes a flexible printed circuit board having an antenna pattern printed thereon.

8. The loop antenna according to claim 4, wherein the antenna pattern unit includes a plated substrate having a plated pattern.

9. The loop antenna according to claim 4, wherein the antenna pattern unit includes a sheet metal in the form of a pattern.

10. The loop antenna according to claim 1, further comprising a magnetic field inductor mounted in the housing and disposed between the antenna pattern unit and the permanent magnet.

11. The loop antenna according to claim 1, further comprising a magnetic field inductor in the vicinity of the antenna pattern unit in the housing.

12. The loop antenna according to claim 10, wherein the magnetic field inductor is formed of a metal.

13. The loop antenna according to claim 10, wherein the magnetic field inductor is formed of ferrite.

14. A loop antenna for a mobile device, the loop antenna comprising:
a display panel mounted in the mobile device; and
an antenna pattern unit mounted at a position of the display panel, opposite to a permanent magnet structure for accommodating a permanent magnet inside the mobile device.

15. The loop antenna according to claim 14, wherein the permanent magnet structure is a speaker.

16. The loop antenna according to claim 14, wherein the permanent magnet structure is a receiver.

17. The loop antenna according to claim 14, wherein the antenna pattern unit is formed on a bottom surface of the display panel, facing the permanent magnet structure.

18. The loop antenna according to claim 14, wherein the antenna pattern unit is formed on a top surface of the display panel, opposite to a surface facing the permanent magnet structure.

19. The loop antenna according to claim 14, wherein the antenna pattern unit is inserted into the display panel.

20. The loop antenna according to claim 17, wherein the antenna pattern unit includes an antenna coil in the form of coils.

21. The loop antenna according to claim 17, wherein the antenna pattern unit includes a flexible printed circuit board having an antenna pattern printed thereon.

22. The loop antenna according to claim 17, wherein the antenna pattern unit includes a plated substrate having a plated pattern.

23. The loop antenna according to claim 17, wherein the antenna pattern unit includes a sheet metal in the form of a pattern.
